(19) United States
(12) Patent Application Publication
(10) Pub. No.: US 2011/0178822 A1
(43) Pub. Date: Jul. 21, 2011

(54) MedicVue.com-Personal Emergency Medical Database

(76) Inventor: Tammie Ann Ringer, Queensbury, NY (US)

(21) Appl. No.: 12/928,036

(22) Filed: Dec. 2, 2010

Related U.S. Application Data
(60) Provisional application No. 61/283,360, filed on Dec. 3, 2009.

(51) Int. Cl. G06Q 50/00

(52) U.S. Cl. 705/3

(57) ABSTRACT

MedicVue.com is an interactive website that provides confidential database storage and retrieval for basic medical information. Access for medical personnel is through a member ID code that is visible on member cards, id tags and silicone bracelets. The code system is a ten character alpha-numeric code that is generated when registering. The code corresponds to entered information that is stored. To maintain confidentiality, no personal information is visible. One area of the database is an Emergency/Medical Records Area that shows the condensed version of a member's entered information; this section is read-only. The second area is the member login area, a password protected section that allows for the entering or editing of information. Database areas of entry include emergency contacts, allergies, immunizations, current medications, physicians, surgical history, implants, organ donor status, medical notes and unique identifying marks sections.

### CROSS-REFERENCE TO RELATED APPLICATION

MedicVue.com-Personal Emergency Medical Database has applied for and was granted a provisional patent on Dec. 3, 2009. Application number issued is 61/283,360.

MedicVue.com is an interactive website that is designed to store and retrieve personal medical information when needed. MedicVue's confidential system is composed of a database that has two separate areas for accessing data entered.

### SPECIFICATIONS FOR MedicVue.com

The confidential system consists of a member's ID code that corresponds to a list of member's own entered information. The personal information of the member is not viewable to either area. This protects the identity of the member if their member ID is lost or stolen. Database topics areas are as follows: emergency contact names and phone numbers, allergies, immunizations, current medications, physicians, surgical history, implants, organ donor status, medical notes and unique identifying marks section.

The view only area (Member Login) and an entry area for entering information or for editing purposes which is password protected and can only are accessed by the member or an assigned authorizing agent that the member has given permission to utilize by revealing their password to them.

The Emergency/Medical Records area is a view text only area that is accessed by entering the MedicVue member's ID code. There is not access to allow any changes of the information listed.

### STATEMENT OF FUNDING

MedicVue.com has not been federally funded by any government agency for research and development.

### BACKGROUND OF THE INVENTION

MedicVue.com was designed and developed through recognizing a need, while utilizing modern technology, to save lives, provide a focused care approach for emergency patients before they arrive at a care facility, decrease medical errors, decrease medical costs, decrease in length of hospital admissions, increase patient mortality and maintain patient confidentiality.

### BRIEF SUMMARY OF THE INVENTION

MedicVue.com has achieved the confidentiality system process by design of the member ID system that is accessible through the website.

Modern technology, through using the internet, incorporates computers that are currently utilized in police vehicles, ambulances, hospitals, physician offices, as well as cell phones. Internet is also worldwide and easily translated if the member is visiting a different country and the member does not speak the language.

New electronic health record systems that are in physicians' offices, pharmacies and hospitals are often times unable to communicate due to HIPAA laws or incompatibility of their operating systems. MedicVue circumvents this dilemma. The basic information that a member enters into their database provides a valuable tool enabling any care provider to have quick access to emergency contacts who may be able to give important medical information about the member and a 1st from their database of other physician's names and office phone numbers, thus a basic starting point of communication. Patients often are too ill, are unconscious, poor historians, or may become unconscious and unable to give accurate medical information about themselves which delays treatment, unnecessary testing or treatment becomes less aggressive due to lack of information about a patient's allergies, current medications and basic medical information.

### DETAILED DESCRIPTION OF THE INVENTION

A MedicVue.com registered member is issued a unique alpha-numeric ten digit code. The numbers zero and one have been omitted from the pool of possible member ID codes to avoid confusion with the letter L and the letter O. The member has also chosen a unique password for their MedicVue.com account when registering. This password allows access to the Member Login area, which is password protected, where the member enters their information and can update or edit their entered information in the future.

Member ID codes are visible on MedicVue.com Member ID “Personal Health Record” cards that state the member's ID, is tagged in red with “Medical Alert” on the card with instructions for Emergency/Medical personnel on the back of the card. MedicVue.com also provides members with a choice of a silicone bracelet or a dog tag style ID for a second type of alert system.

The issued MedicVue.com member ID code can be used in the Emergency/Medical Record Area for viewing only entered information; thus if a member does not have any allergies and therefore did not enter any information in that section of their database, no information will appear in this view text only area. This view text only area is also printable.

The MedicVue.com process saves time by having access to a patient's basic medical information in just one click, decreases patient's paperwork, decreases medical errors, improves physician's communication and provides a focused care approach to a patient's current medical problem by knowing in advance their basic medical information.

1. MedicVue.com's confidential HIPAA compliant system that provides access to a member's personal medical database utilizing a designated MedicVue Member ID Code that never revealing any personal information in any area of the website database.

2. MedicVue.com's two separate areas of the confidential database: a) Member area that is password protected, b)Emergency/Medical Area that is a view text only that does not allow editing.
